(19) United States
(12) Patent Application Publication
(10) Pub. No.: US 2010/0320758 A1
(43) Pub. Date: Dec. 23, 2010

(54) PIPE COUPLER WITH SPLIT GASKET AND GRIPPING CLIPS

(76) Inventor: DAVID E. SISK, Bonne Terre, MO (US)

Correspondence Address: Paul M. Denk, 763 S. New Ballas Road, Suite 305, St. Louis, MO, 63141, US

(21) Appl. No.: 12/817,378

(22) Filed: Jun. 17, 2010

Related U.S. Application Data
(60) Provisional application No. 61/218,142, filed on Jun. 18, 2009.

(51) Int. Cl. F16L 25/06

(52) U.S. Cl. 285/420

(57) ABSTRACT

A pipe coupler has two arms, a gasket lacking a centered ridge, and clips upon the arms that grip pipes regardless of their end condition. The hinged arms define an annular opening that encircles the gasket and the ends of coupled pipes. The arms connect with a hinge located to the interior of the arms and with a rounded internal edge that minimizes pinching. The arms secure using a cam lever or tee handle. The cylindrical gasket, solid or split, with securing buttons, has an even number of concentric ridges, no ridge extending between the pipes. The gasket's inner diameter fits a pipe's outer diameter. The gasket has ends with a wavy surface that mate completely upon a radius and a self lubricating material. The clips bite into the pipes' surface for continuous grounding.

### CROSS-REFERENCE TO RELATED PATENTS

This non-provisional application claims priority to the pending provisional application 61/218,142 filed on Jun. 18, 2009 and is owned by the same inventor.

### BACKGROUND OF THE INVENTION

This invention relates generally to pipe couplers, more specifically to an adjustable coupler with an improved gasket and clips where the coupler joins pipes regardless of their end surface condition.

Clamps and couplers used to connect sections of pipe, end-to-end, have appeared in the pipe connecting art over the years. Such clamps often are employed to connect sections of pipe or hopper tees on tank trailers and cars. In certain applications, particularly in dry bulk hauling, the integrity of the seal at the pipe connections is critical in preventing cross contamination of the products sequentially hauled in the tanker trailers. Often pellets or powders travel from a factory to a manufacturing plant in tank trailers. The pellets or powders unload through gravity gates, valves, or hoppers located on the bottom of the tank trailers. Hopper tees attached to the bottom of the hopper are connected to collection pipes. Pressurized air, or alternatively sometimes a vacuum, is employed through the pipe to accelerate the emptying of the dry bulk products.

The pressurized air enters a hopper from above and below through aerators then exits into the collection pipes. Pressurized air also enters the collection pipes from the upstream end, often proximate the tongue of a tank trailer. The pressurized air moves product along from a hopper through a tee and into the collection pipes for delivery. Dry bulk material though often moves in an irregular manner and may fluctuate in volume passed through collection pipe in a given time. The fluctuations in material flow and the air pressure in the collection pipe tend to separate adjacent pipe sections slightly, most of the time, and greatly, on rare occasions, leading to a disconnection or a rupture of the collection pipe.

Accounting for the slight separation in adjacent ends of pipes, couplers include a gasket. The gasket fits snugly around the two ends of two adjacent pipes. The gasket is generally a hollow cylinder with a thin wall that fits within the arms of a coupler. Gaskets can be formed as a single cylindrical piece or as a strip then bent into cylindrical form. During installation, a gasket abuts the arms which are often hinged and risks being pinched when the arms close upon a pivoting connection.

In allowing slight axial movement of pipe ends within a coupler, the gasket flexes along its wall, generally upon the inside surface of the gasket. As the gasket flexes, a small portion of the gasket may extend inwardly and become pinched by the adjacent ends of pipe. Over time, repeated pinching wears down the gasket and leads to leakage of product out of the coupled pipe ends.

Gaskets molded as flat strips generally have a constant thickness and square cut ends. Upon folding into a cylinder, strip gaskets attain an inner radius and an outer radius. The outer radius generally exceeds the inner radius occasionally by more than the flat thickness of the gasket strip. The difference in the two radii leads to an incomplete joining of the gasket ends. In attaining the cylindrical form, the constant thickness of the strip gasket and abutting ends lead to a leak prone gasket joint as later described in FIG. 12c.

Generally, dry bulk product must empty completely between loads to prevent contamination of later loads, a situation that trucking companies and manufacturing plants avoid at high cost. For example, if the hauler carries black plastic resin beads, all of the black plastic resin must be removed from the tank trailer, as well as the hopper and piping often coupled together, to prevent contamination of a later load of white or other colored plastic resin. In such an event, contamination of even a small amount can destroy a load and force its disposal at high costs to both the manufacturing plant and the trucking firm.

### DESCRIPTION OF THE PRIOR ART

Manufacturers and haulers have known that separation of adjacent pipes and fittings and contamination can occur at the point of coupling the pipes to hopper tees and from pipe to pipe. Prior art clamps employ gasket seals and clamp edges that can trap product. FIGS. 1-4 illustrate components of a typical prior art clamp. Prior art clamp 1 shows a typical overcenter clamp having two semi-circular sides 3 and 5 connected by a hinge as at 7. A conventional overcenter lever 9 and cam 10 clamping means draws the two sides, or halves, tightly together to surround the joint for clamping, as in the end to end connection of pipes P1, P2. A deformable gasket 11 lines the interior groove 12 of clamp 1 as shown in FIGS. 3 and 4. The prior art gasket 11 has outer walls 13 and 14 with a center member 16 designed to deform and press against the pipe joint. Gaps 18 and 20 between the respective sides and the center member create grooves that collect and trap material, such as dry bulk plastic resins or flour. Once such material lodges deep in those gaps 18 and 20, removing it becomes nearly impossible and trucking firms often replace the entire gasket well before the end of its useful life, thus raising costs.

Besides cross contamination, the prior art clamps such as clamp 1 have other difficulties. Such prior art clamps have no means for adjustment. The clamp, even when new, opens and closes stiffly. Lever 9 and cam 10 wear during use until clamp 1 loosens and fails. This type of clamp requires early changing, replacing, and discarding, leading to waste and increased costs.

Furthermore, the clamps shown in FIG. 1 have cast iron and mild steel parts that corrode from exposure to the environment as a tank trailer travels down the roads subject to rain, snow, and deicing compounds among other things. Once corroded, the clamp becomes nearly impossible to remove from the pipe P or hopper T. The user must pry the lever 9 with a pry bar or length of pipe. Then the user must beat two halves 3 and 5 apart with a hammer to separate them.

Along with corrosion and accumulation of product in gaskets, prior art couplers also have a weakness in relation to electrical charge, or grounding. During unloading of dry bulk materials, the materials abrade themselves at the pellet level and abrade adjacent piping and fittings where the various abrasions create static electrical charge. Such static electrical charge can accumulate and lead to electrical shock to persons who touch piping, spontaneous combustion of select dry bulk materials, or up to an explosion in the piping, a hopper, or an entire trailer. The prior art couplers reduce the risk of static electrical charge by a driver connecting a ground strap or ground wire, usually with a spring clamp, to a pipe. However, the prior art couplers, even with ground straps, do not provide a confirmed continuous ground circuit. The prior art couplers often have an intermittent connection between adjacent piping which occasionally leads to an arc or spark of static electricity jumping between adjacent piping that may ignited the bulk material. In prior art couplers, the gasket acts as electrical insulator and it also inhibits metal to metal contact between a coupler and adjacent piping. Further, debris, product, corrosion, and other contaminants also degrade the ground circuit, leading to a poor connection and intermittent connectivity. Prior art couplers made of plastic lack the ability to conduct electrical charge and hence offer no ability to ground couplers and piping.

The prior art coupler of Morris Coupling Co. of Erie, Pa., provides a ground strap for its band style clamp however, the ground strap merely lays upon the surface of each pipe but does not penetrate into its surface. The prior art couplers of Sure Seal, Inc. of Mineral Point, Mo., call for a grounding wire across a coupler between two adjacent pipes. Most drivers though forget to install the grounding wire leading to intermittent grounding because the rubber gasket acts as an insulator and a spacer that holds the coupler slightly away from the pipes, preventing a ground. Other tank trailers, such as for starch and flour, have integral grounding cables that connect to bins into which they unload. These ground cables stop the accumulation of static electrical charge while the tanker is grounded but the piping between the couplers remains ungrounded. Over the years, various incidents have occurred where static electricity has caused an explosion at an unloading site with starch, flour, or other products of a fine powdery form. A coupler that grounds itself on each installation, as in the present invention, provides a significant safety and regulatory benefit to bulk material haulers.

The U.S. Pat. No. 5,540,465 to Sisk shows three forms of a coupler that join specific end conditions of pipes. These couplers also use an adjustable bail that secures one arm upon another. Two embodiments of the couplers have a rib that mechanically secures to a groove in a pipe and one embodiment has a flat flange that abuts the surface of a smooth pipe.

The U.S. Pat. No. 5,722,666 to Sisk shows a pipe coupler gasket that has triangular ridges. The gasket generally has three symmetric ridges where a ridge can insert between the two adjacent pipe ends.

The design patent to Sisk, Des. No. 372,765 illustrates a gasket having beveled top and bottom edges and three internal rings as in FIG. 4. The rings have a generally pointed or triangular shape while the gasket is generally of a solid ring construction.

Finally, such clamps lack versatility because they do not easily connect different pipe sections together. For example, the clamp may have to connect two sections of smooth pipe, connect two sections of grooved pipe, or connect a smooth pipe to a grooved pipe. Prior art clamps may work to connect pipes of matching surface condition, but do not accommodate different styles of pipe.

A unique aspect of the pipe coupler with clipped gasket includes clips upon the coupler that bite into pipes for coupling, radiused coupler arms, and a gasket without a center ridge.

### SUMMARY OF THE INVENTION

A pipe coupler with clipped gasket has two arms that have a radiused leading edge, clips upon the arms outside of a gasket, a gasket lacking a center ridge that grip pipes regarding of their surface condition, and the gasket has a split version with two inherent radii and an undulating end cut preventing product leakage at the joining of the ends. The coupler allows coupling of two pipes of any end surface condition including dissimilar end conditions. This coupler has a semi-circular first arm and a semi-circular second arm which, together, define an annular opening that encircles the gasket and then the respective ends of the pipes for coupling. The arms connect with a hinge more closely located to the interior of the arms, that is, closer to the gasket. The hinge has a rounded internal edge that minimizes attracting and pinching the gasket. The arms secure opposite the hinge using a hook bolt closed by a cam lever. The cam lever includes an aperture for insertion of a seal or other tamper indicating means. Alternatively, the arms secure in a closed position using a tee handle opposite the hinge. The gasket is either a solid single piece or a split piece with buttons that secure it to each arm. The buttons engage slotted holes in each arm so that the gasket can slide ever so slightly during installation. The gasket has a plurality of concentric ridges, generally even in number, so that no ridge extends into the pipe to pipe joint. The solid embodiment of the gasket has an internal diameter sized to accommodate the outer diameter of a pipe. Further, the gasket material includes lubrication as part of its construction that allows for ready placement of the gasket either as a solid or a split version around the pipes. The clips also bite into the material of the arms allowing passage of charge through the coupler when grounded.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a pipe coupler with clipped gasket that secures into the surface of abutting pipes. Another object of the present invention to provide a pipe coupler with clipped gasket that seals the joint of abutting pipes without intrusion of the gasket between two pipe ends.

Another object of the invention is to provide a pipe coupler that connects pipes of the same outer diameter end to end with any end surface condition, whereas the coupler connects two sections of grooved pipe, a grooved pipe to a smooth pipe, or two sections of smooth pipe.

Another object of the present invention is to provide a pipe coupler that has a gasket that compresses ridges along the pipe sections that serve as multiple barriers to the exit of air and material through the coupler.

Still another object of the present invention is to provide a pipe coupler with clips that increase their engagement into the pipe surface when air pressure urges the pipes apart within the coupler.

Still another object of the present invention is to provide a pipe coupler with arms having a radius on their internal edges that prevents pinching of the gasket by the arms.

Another object of the present invention is to provide a pipe coupler that has an inwardly located hinge point that avoids the arms pinching the gasket during closure of the coupler.

Still another object of the present invention is to provide such a pipe coupler made from long lasting corrosion-resistant material.

Yet another object of the present invention is to provide a pipe coupler that requires no tools to couple or uncouple.

Yet another object of the present invention is to provide a pipe coupler that can be opened and closed from only one side.

Still another object of the present invention is to provide such a pipe coupler with clipped gasket that provides an indication when tampering has occurred.

Still another object of the present invention is to provide such a pipe coupler with clipped gasket that establishes continuous paths for electrical static charge to follow from one pipe contacting the coupler to the next pipe in line.

Still another object of the present invention is to provide a pipe coupler that is durable, long lasting, economical to manufacture.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention

### BRIEF DESCRIPTION OF THE DRAWINGS

In referring to the drawings,

FIG. 1 shows a perspective view of a closed prior art coupler;

FIG. 2 shows a perspective view of a prior art coupler closed upon two pipes end to end;

FIG. 3 describes a gasket of a prior art coupler;

FIG. 4 illustrates a sectional view of the prior art gasket;

FIG. 5a shows a detailed view of a prior art coupler arm upon a gasket in a smooth to smooth pipe connection and FIG. 5b shows a sectional view through a prior art arm of a smooth to smooth pipe connection;

FIG. 6a shows a detailed view of a prior art coupler arm upon a gasket in a grooved to a grooved pipe connection and FIG. 6b shows a sectional view through a prior art arm of a grooved to a grooved pipe connection;

FIG. 7a shows a detailed view of a prior art coupler arm upon a gasket in a smooth to a grooved pipe connection and FIG. 7b shows a sectional view through a prior art arm of a smooth to a grooved pipe connection;

FIG. 8 shows a perspective view of the present invention when closed;

FIG. 9 describes a front view of the present invention when closed;

FIG. 10 illustrates a detailed sectional view of the present invention when closed;

FIG. 11 provides a front view of the present invention when open;

FIG. 12a shows a perspective view of a solid gasket, FIG. 12b shows a split gasket in a perspective view, and FIG. 12c shows a detailed view of the end to end joining of a split gasket;

FIG. 13 describes a perspective view of the present invention when closed and with a solid gasket therein;

FIG. 14 provides a perspective view of the invention when open and with a split gasket therein;

FIG. 15 shows a detailed sectional view of a button securing a split gasket to the arms of the invention; and,

FIG. 16 provides a front view of an alternate embodiment of the present invention when open.

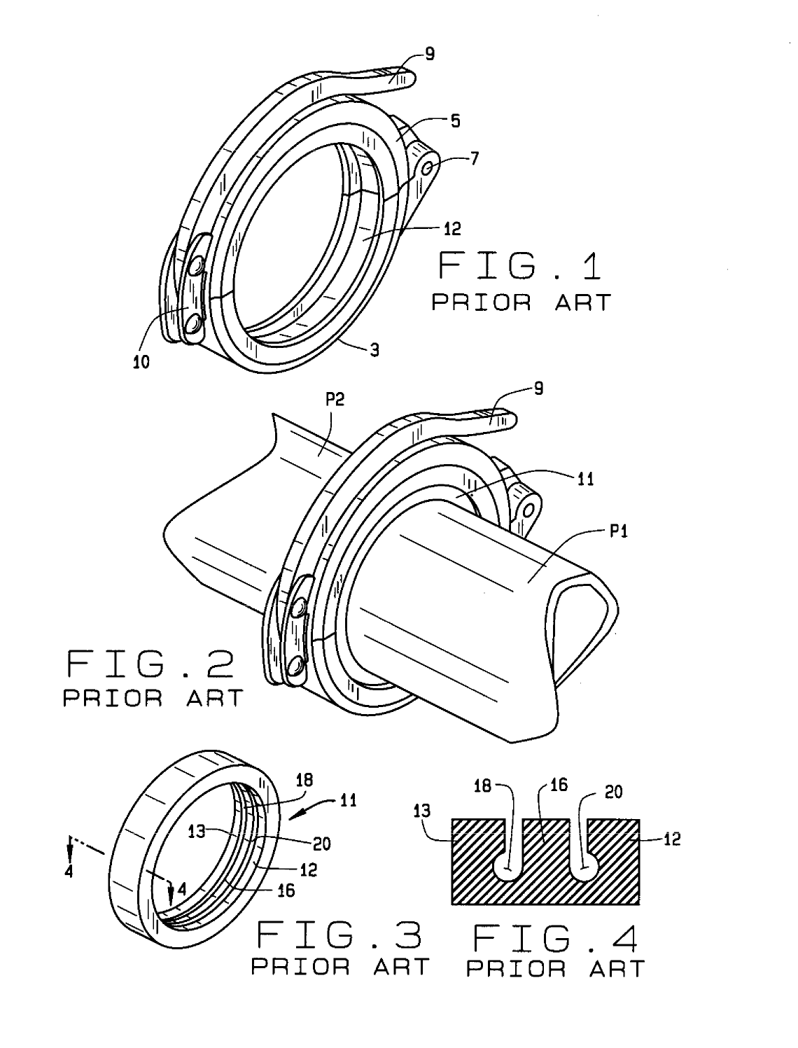

The same reference numerals refer to the same parts throughout the various figures.

### DESCRIPTION OF THE PREFERRED EMBODIMENT

The present invention overcomes the prior art limitations by providing a coupler and cooperating gasket that fit upon two pipes in an end to end connection regardless of the pipe surface condition. Tanks, tank trailers, hoppers, and other bulk material handling equipment move the bulk material through various fittings and on into pipes. Pipes have typical lengths and operators of bulk material handling equipment connect pipes thus reaching from a tank to a delivery point. The bulk material handling industry along with tank and trailer manufacturers have settled upon two pipe end conditions, smooth and grooved, that lead to three types of end to end connection.

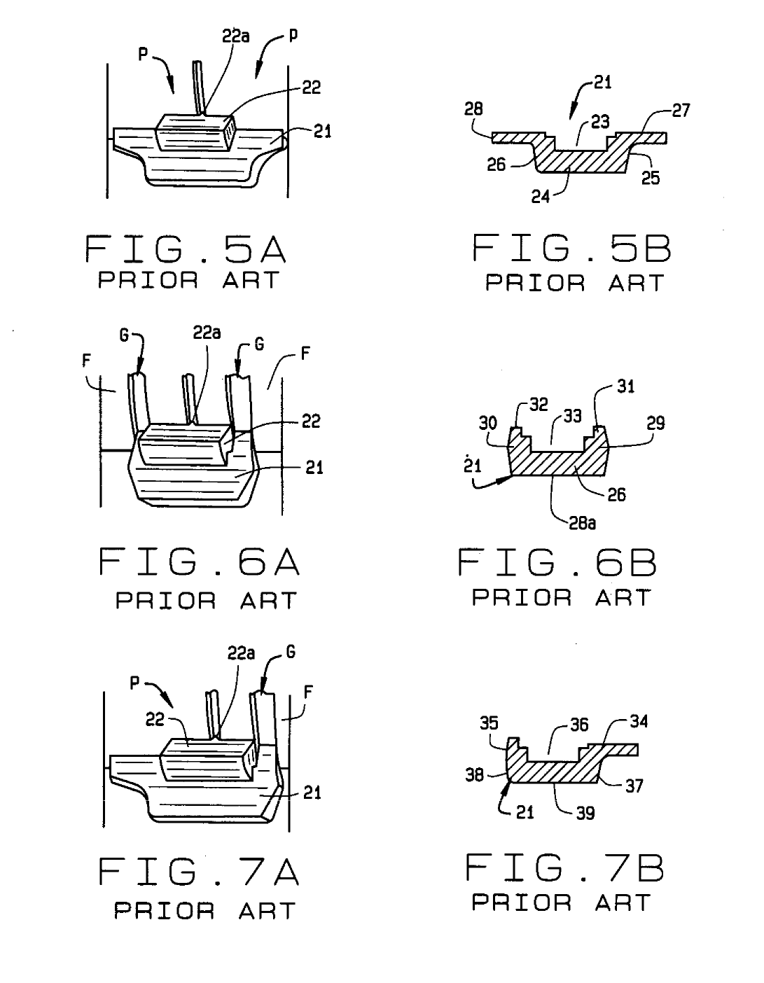

FIG. 5a shows a prior art coupler arm 21 upon a gasket 22 at the connection of two smooth pipes, as at P. The gasket has a single ridge 22a that intrudes between the machined ends of the two pipes. The ridge is generally centered upon a symmetric rectangular cross section gasket forming a ring shape around the circumference of a pipe P. The coupler arm 21 is generally symmetric and fits over the gasket as the gasket fits within a groove 23 shown in the FIG. 5b sectional view. The coupler arm has a bottom wall 24, opposite the groove, a first sidewall 25 and an opposite second sidewall 26. The respective walls in their positions as shown define the groove 23. Outwardly from the first sidewall, an integral flange 27 extends from the groove and spaced away from the bottom wall. Maintaining symmetry, the second sidewall also has an integral flange 28 extending outwardly from the groove and in line with the integral flange from the first sidewall. The integral flanges abut the surface of the pipes P when the coupler is used. The groove 23 has a generally rectangular shape that admits the gasket as shown in FIG. 5a.

FIG. 6a shows a prior art coupler arm 21 upon a gasket 22 but at the end to end connection of two grooved pipes F. A grooved pipe has a groove G machined into its end generally at a constant distance away from the end and at a constant depth around the pipe. As before, a centered ridge 22a on the gasket intrudes between the two grooved pipes F when the coupler arm is closed. The coupler arm extends into the groove G and mechanically secures one grooved pipe adjacent to the other grooved pipe. The coupler arm has a symmetric cross section as shown in FIG. 6b, of a generally U shape. The coupler arm has a bottom wall 28 generally parallel to the length of a pipe F when installed, and two mutually parallel and spaced apart sidewalls, a first sidewall 29 and a second sidewall 30 as shown. The sidewalls extend perpendicular to the bottom wall and each defines a rib as at 31 on the first sidewall 29 and as at 32 on the second sidewall 30. The sidewalls and the ribs define a groove 33 that seats the gasket 22. The ribs have a cross section that fits snugly within the groove G of each pipe.

Then FIG. 7a shows a detailed view of a prior art coupler arm 21 upon a gasket 22 but in the connection of a smooth pipe P to a grooved pipe F with its groove G. The gasket has a centered ridge 22a as before the intrudes between the ends of the pipes. As the coupler is installed, it compresses the gasket around the pipe at the joint and spreads the ridges to fill up the inside diameter of the clamp to provide a greater sealing surface at both the pipe joint. The gasket has no gaps or grooves to collect material. The gasket then fits into a coupler arm 21. Unlike the prior coupler arms, this coupler are is asymmetric. The sectional view of FIG. 7B shows the asymmetric coupler arm with an integral flange 34 and an opposite rib 35 and groove 36 between them that receives the gasket. The integral flange extends from a first sidewall 37 and the rib 35 extends outwardly from a second sidewall 38. The sidewalls are spaced apart and generally parallel. The sidewalls extend perpendicular from the ends of a bottom wall 39. The integral flange abuts the smooth pipe surface during usage while the rib engages the groove G thus the rib is slightly more away from the bottom wall than the integral rib. These prior art couplers and their gaskets accommodate the various pipe end to end connections. However, each end to end combination requires a specific coupler and the coupler of FIG. 7A requires a user to apply it in one direction only.

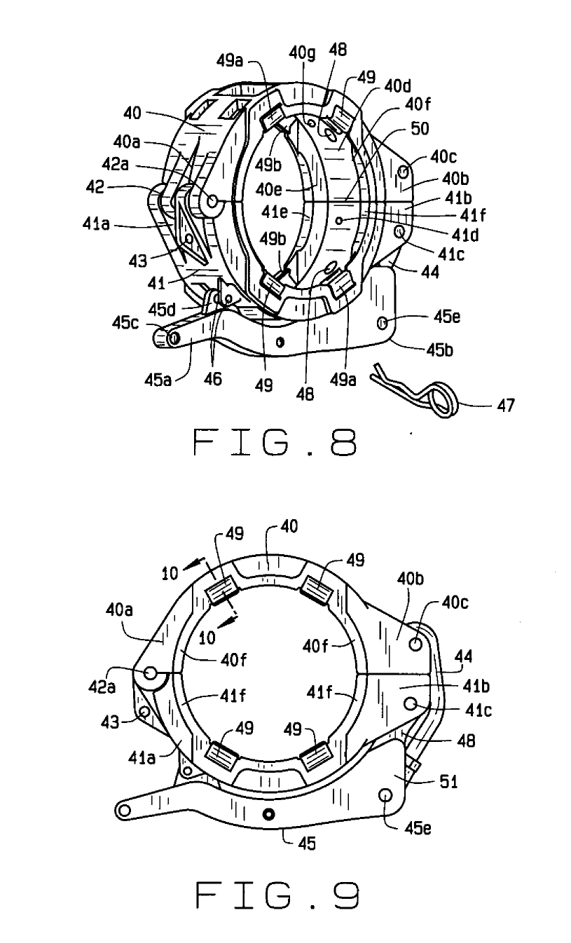

The present invention appears in FIG. 8 with a first arm 40 and an opposite second arm 41 here shown in a closed position. The first arm has a generally semi-circular shape and the second arm has a generally semi-circular shape that cooperate to form a round aperture with a diameter sized to the outside diameter of a pipe, generally from approximately 4 inches to at least 6 inches. The first arm has two opposite ends, a first end 40a and a second end 40b locating generally upon the diameter of the semi-circular shape. The second arm also has two opposite ends, a first end 41a and a second end 41b locating generally upon the diameter of the semi-circular shape generally as a mirror image to the first arm. The first arm has a hinged connection as at 42 to the second arm where the first ends 40a, 41a mutually engage. More particularly, the first end 41a of the second arm 41 also includes a tab 43 with a hole there through for a seal or other tamper indicating means, not shown. The tab is generally perpendicular to the second arm 41.

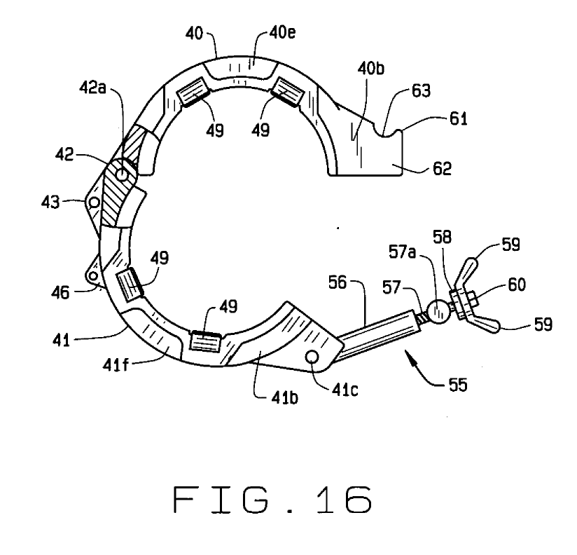

The second arm secures the device closed upon the first arm utilizing a closure mechanism. The closure mechanism includes a hook bolt with a cam lever and a tee handle. A hook bolt 44 engages the second ends 40b, 41b. The hook bolt has an inverted J shape as later shown and the bight of the hook bolt engages over a pin 40c in the second end 40b of the first arm 40. The shank of the hook bolt bends and extends downwardly over the second end 41b of the second arm 40 to the cam lever 45. The cam lever is generally elongated and slightly curved to follow the exterior of the second arm. The cam lever has a first end 45a and an opposite second end 45b. The first end extends generally outwardly from the invention and spaced below the hinged connection. The first end may have a hand grip or foot pedal that assists in opening of the coupler. The first end has a hole there through 45c that again admits a seal or other tamper indicating means, not shown. Inwardly from the hole 45c, the first end has a tab 45d with its own hole that cooperates with a tab 46 and its hole to receive a safety pin 47 or other securing device such as a zip tie or chain. As shown in this figure, the cam lever inwards from the first end generally follows the second arm and the lower portion of the cam lever is generally tangent to the second arm when closed. The second end 45b of the cam lever includes a pin 45e upon which pivots the hook bolt 44. The cam lever extends upwardly from the pin 45e in a third arm 48 as later shown in FIG. 9. The third arm pivots upon a pin 41c so that when the first end is moved away from the second arm, the cam lever pivots downwardly and outwardly from the second arm opposite from the hinged connection 42 and loosening the hook bolt 44. With the cam lever open, the second arm can drop away from the first arm, allowing for easy removal as later shown in FIG. 11. Alternatively, the first arm utilizes a tee handle that releasably secures to the second arm as later described in FIG. 16.

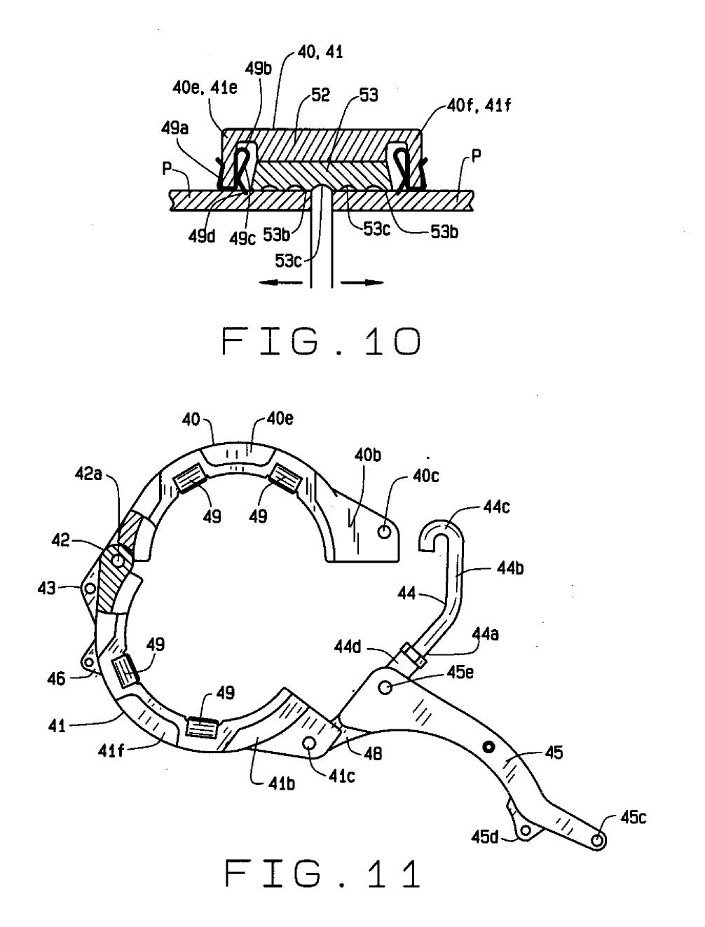

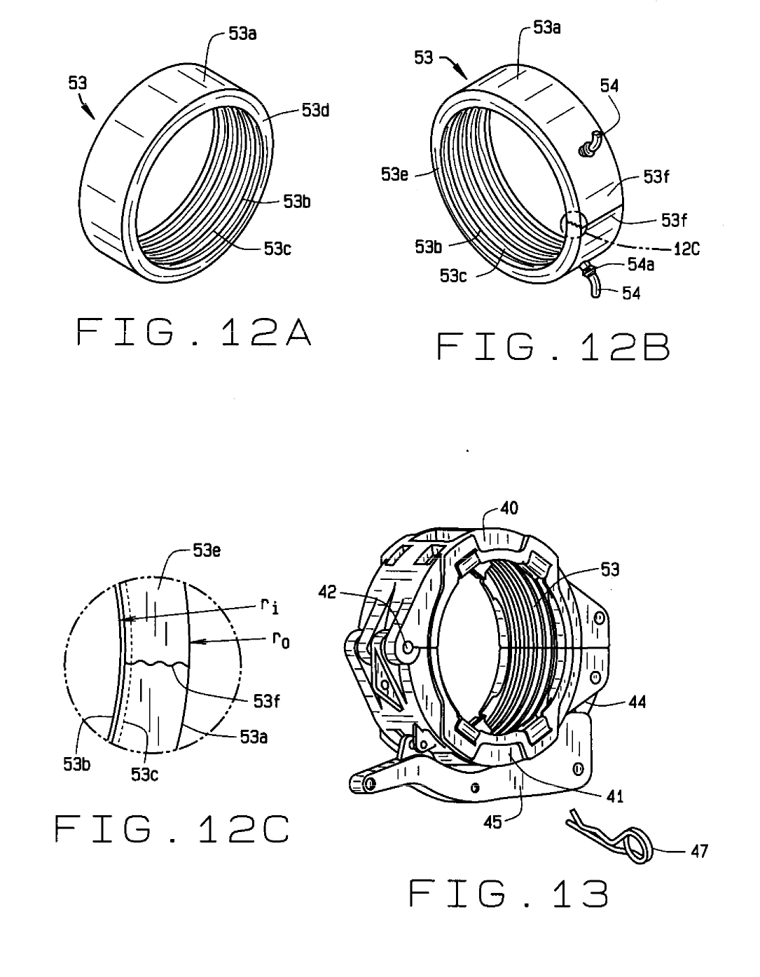

Looking inwardly, the first arm 40 has a groove 40d extending along its length. The groove forms between two sidewalls 40e, 40f, mutually spaced apart and generally parallel, and an outer wall 40g. The outer wall is generally perpendicular to the sidewalls and parallel to the length of pipes joined by this invention. In an alternate embodiment, the outer wall has at least one elongated slot 48 for securing a split gasket as later shown in FIGS. 12b, 15. Upon each sidewall, the first arm has at least two clips 49 spaced symmetrically. Each clip extends along the exterior of the sidewall as at 49a and along the interior of the sidewall as at 49b. The clip also returns from the interior of the sidewall as later shown in FIG. 10 to engage the surface of a pipe P. Akin to the first arm, the second arm 41 has a groove 41d extending along its length. The groove forms between two sidewalls 41e, 41f, mutually spaced apart and generally parallel, and an outer wall 41g. The outer wall, generally perpendicular to the sidewalls, also extends parallel to the length of pipes joined by this invention. In an alternate embodiment, the outer wall has at least one elongated slot 48 for securing a split gasket as later shown. Upon each sidewall, the first arm has at least two clips 49 spaced symmetrically. Each clip extends along the exterior of the sidewall as at 49a and along the interior of the sidewall as at 49b. The clip also returns from the interior of the sidewall.

And the first arm and the second arm come together at their first ends 40a, 41a and second ends 40b, 41b respectively. Each end also has a radius or curve applied to it. The curve eases the closure of one end upon another, removing an edge that could grip a gasket or finger. Curving of the ends, as at 50, prevents the arms from pinching a little portion of the gasket during closure of the arms and damaging the gasket or breaking the seal of the gasket to the pipes P, G.

Moving from an perspective view, FIG. 9 shows the invention from the front and when closed. The first arm 40 abuts the second arm 41 at their first ends 40a, 41a, and their second ends 40b, 41b leaving a circular aperture therein to admit a gasket and a pipe. The circular aperture is defined by the sidewalls 40e, 40f, 41e, 41f with the sidewalls 40f, 41f here shown. The diameter of the circular aperture and hence the sidewalls is generally that of the outside diameter of a pipe P, G. The sidewalls each have at least two clips 49 spaced thereon, generally symmetric about two axes as shown. The clips extend slightly into the diameter of the circular aperture, also shown in FIG. 10.

The first arm secures to the second arm at the hinged connection as at 42 and at the hook bolt 44. The hook bolt secures upon a pin in the second end of the first arm and then extends downwardly and outwardly from a pin 41c in the second end 41b of the second arm 41. The pin 41c pivotally connects to the third arm 48 of the cam lever 45. The third arm extends downwardly from the pin and joins a shoulder 51 of the cam lever. The shoulder also includes pin 45e in the second end 45b upon which the shank of the hook bolt 44 pivots.

Viewing the working of the clips 49 more closely, FIG. 10 shows the clips in action upon pipes P in an end to end connection. An arm 40 or 41 of the coupler has two spaced apart sidewalls, 40e, 40f, or 41e, 41f, shown generally parallel in this section view. The sidewalls are generally thinner than the width of an arm and extend outwardly at a diameter greater than the central aperture. Upon at least two locations on each sidewall of each arm, clips 49 slip upon a sidewall. Each clip has an inverted somewhat U shape with a hook portion 49a, that extends to a bight portion 49b, and that returns in a leg portion 49c. The hook portion itself has a flat bottomed U shape with a slight inward bend of its outer arm so that the hook portion slips upon the sidewall. The flat bottom of the hook allows for a firm seat of the clip 49 against the sidewall. The hook portion has a length generally less than the overall length of the clip and less than the height of the sidewall. Inward from the outer arm, the hook extends for a distance greater than the outer arm length as shown into the bight portion 49b. The bight portion has at least a semi-circular curve formed therein and transitions the clip from the hook portion into the leg portion 49c. The leg portion also has an inward bend, that is, back to contact the hook portion. After its contact upon the hook portion, the leg portion bends outwardly from the clip and extends below the flat bottom of the hook portion. The leg portion has a greater length than the outer arm of the hook portion. The outward bend of the leg portion allows it to grip the surface of a pipe P, as at 49d, when the pipe has low pressure within it and as pressures rise or fluctuate inside the pipe during various stages of unloading. When biting, or gripping the surface of a pipe, the clips, generally steel, provide metal to metal contact that allows for transmission of electrical charge from one pipe, through a clip, into an aluminum arm of the coupler, into an opposite clip, and into a second pipe. The clips in cooperation with the arms make a ground path that extends through metal parts of the coupler. The clips provide excellent gripping power from the coupler to the adjacent piping but also provide a continuous electrical ground between adjacent pipe sections. As above, the clips bite into the pipe surface while remaining in contact with the metal first and second arms of the coupler thus creating a secure electrical connection for each installation of the invention upon adjacent pipe sections. The electrical connection avoids the adverse effects of debris and other contaminants as in the prior art couplers. Because the clips bite into the pipe surface during each installation of the first and second arms of the invention, a ground strap or a ground wire is no longer necessary.

The opposite sidewall also has a clip of the same geometry as described though applied in a reverse manner. Inwardly from the sidewalls, the arm 40, 41 has an increase in its thickness for a substantial part of its width as at 52. This thickened portion 52 exceeds the sidewall thickness. The thickened portion provides a somewhat U shape to each arm's cross section. The thickened portion has a slight roughness and receives a gasket 53. The preferred aluminum first arm and aluminum second arm go over and around the gasket. Though the gasket material may function as an insulator, the metal parts around the gasket allow for continuous grounding of connected pipes coupled by the invention. With the clips 49 outwardly from the gasket 53, the coupling is adapted to contact adjacent pipes P and make a grounding circuit. The gasket has an outer surface 53a that engages the thickened portion of an arm. Opposite the outer surface, the gasket has a plurality of ridges 53b, generally concentric and of an even number, that abut the surface of adjacent pipes P. Between adjacent ridges, the gasket has a generally curved trough, or valley, as at 53c. The even number of ridges locates a valley 53c at the joint of the two pipes. Because of the centered valley, the gasket does not intrude between the two pipes at their connection and avoids the risks and damage to the gasket and broken seal from pinching the gasket between pipe ends as occurs in the prior art. As shown, the ridges generally abut the surface of the pipes and the return legs 49c grip or bite into the surface of the pipes. The outward bend of the return leg, that is, towards the gasket from either sidewall, allows the clips to resist the pipes P expanding mutually outward when subjected to pressurization, usually up to two atmospheres, two bars, or approximately 29 psi. The return legs also grip into a groove G of a grooved pipe end, if present. As the pressure increases within the pipes, the separation of the pipe ends from one another increases the bite of the return legs into the pipe surface. The clips are generally of hardened steel for biting into the pipe surface and resisting the repetitive bending of the return leg that occurs over many pressure fluctuations.

After usage of the coupler of this invention or for its installation upon two pipes, the first arm 40 is opened from the second arm 41 as shown in FIG. 11, which is generally the opposite view from FIGS. 8, 9. During opening, a user removes the safety pin 47 and the seal from their respective holes, and then presses upon by hand or steps upon by foot the first end 45a of the cam lever. This action rotates the cam lever upon the pin 41c generally below and outwardly of the second arm 41 and lifts the hook bolt 44 from the pin 40c which allows the second arm to swing freely down. The hook bolt has an adjustable shank 44a that threadily engages a pivot block 44d upon the pin 45e in the second end of the cam lever 45. From the shank 44a, the hook bolt proceeds through its bend at 44b to its bight 44c of a generally semicircular shape akin to a hook. The bight 44c rests upon the pin 40c when the hook bolt has closed upon the first arm. As before the first arm 40 and the second arm 41 have clips 49 spaced upon their sidewalls 40e, 40f as shown. Opposite the second ends 40b, 41b of the arms and the cam lever, the arms have their hinged connection 42 where a pin 42a extends through the first ends 40a, 41a. More particularly, the first ends in the vicinity of the hinged connection are generally rounded as at 42b. The rounding of the first ends has a diameter of at least twice that of the pin 42a and extends the first ends slightly inward to the central aperture. The slight round extension of the first ends abuts any portion of the outer surface 53a of a gasket. The first ends gently urge the outer surface 53a away from the movement of the hinge and towards the central aperture. These rounded ends avoid pinching the gasket as occurs in prior art hinged connections with offset hinges and flat or non-rounded abutting faces.

As mentioned in FIG. 11, the coupler includes a gasket 53 here shown in FIG. 12a as a solid gasket made as a single continuous ring or hollow cylinder. The gasket has its outer surface 53a, and a plurality of ridges 53b and troughs 53c opposite the outer surface. The ridges are generally even in number and the troughs one more in number than the ridges so that a trough is located at the end to end joint of two pipes P joined by this invention. The gasket has a thickness and a front face as at 53d. The front face and its opposite rear face 53e abut the sidewalls 40e, 40f, 41e, 41f of the arms when the coupler is installed upon two pipes. The solid gasket, particularly the inside diameter between ridges precisely matches the outside diameter of a pipe so that the gasket slides easily upon the pipe during installation. This inside diameter of the gasket avoids the stretching and thinning during installation of prior art gaskets.

The gasket 53 also comes in a split single piece as shown in FIG. 12b. The gasket has a rear face 53e that abuts the sidewalls 40e, 40f, 41e, 41f of the arms when the coupler is installed. The gasket has an even number of ridges 53b and valleys 53c one more in number than the ridges as previously described. The gasket also has an outer surface 53a that forms the gasket into a ring when ready for closing of the second arm upon the first arm. Unlike the solid gasket, the split gasket has two free ends 53f that come together as shown when ready for installation. The free ends 53f have generally undulating, that is wavy, shape going across the thickness of the gasket, as later shown in FIG. 12c. The free ends mutually engage so that the wavy shape operates similar to a keyway and impedes the direct flow of product out of the joined ends. This gasket also has at least two pull tabs 54, or buttons, one locating proximate each free end 53f. The pull tabs engage the holes 48 in each arm 40, 41 of the coupler as later shown. Each pull tab is generally elongated, cylindrical, and with a diameter less than the thickness of the gasket. Each pull tab also has a thickened portion or wedge 54 for a small portion of its length that secures the gasket into an arm as later described. Though the gasket comes in solid ring and split versions, the gasket has a formulation of a rubber based material with internal lubrication thus avoiding users applying external lubricants in the field.

Looking at the joining of the free ends 53f in the split gasket, FIG. 12c shows the gasket and free end construction in more detail. The ridges 53b attain in inside radius, rᵢ when the free ends are joined as shown to form the aperture that snugly fits upon a pipe's exterior surface. The valleys 53c also have their own inside radius generally rᵢ plus the valley depth. Opposite the ridges, the outside surface 53a of the gasket attains an outside radius, rₒ that generally matches the innermost radius of the first arm and the second arm. As shown, the outside radius exceeds the inside radius. This view shows the gasket on edge with the rear face 53e in the foreground. Though the split gasket has a thickness, the split gasket also has the outside radius, rₒ and the inside radius, rᵢ which adjust the thickness slightly and the fit of the free ends much closer. Though formed flat, the split gasket has a length of the outside surface 53a slightly more than the ridge 53b. The slight increase in length comes from the outside radius exceeding the inside radius.

The difference in the two radii, rₒ and rᵢ allow the split gasket to attain a curved form with a tight end connection when installed in contrast to prior art gaskets made as a strip in flat form and then bent. The split gasket of the present invention is made in cylindrical form and then cut through its thickness from the front face to the rear face along one line only. The cut allows a user to gently open the gasket and slip its free ends over and around two abutting pipe ends from one side. The free ends 53f each have a generally undulating, or wavy, shape across the thickness of the gasket. The wavy shape extends from the outside surface inwardly towards the ridges. The free ends have cooperating wavy end surfaces that mutually engage and prevent a straight, direct flow path from the pipe surface through the joined ends and out of the gasket. The wavy surfaces of the free ends 53f operate similar to a keyway that fits the two ends together and prevents the ends from sliding upon each other. More particularly, one end 53f has a positive wavy surface while the other opposite end has a negative wavy surface that mate to join the ends as shown.

FIG. 13 shows the coupler of the present invention in a closed position able to seal two abutting pipes end to end. The coupler and its cooperating gasket 53 and clips 49 can seal adjacent pipes regardless of end condition. The coupler has a first arm 40 and a second arm 41 in a hinged connection 42 closed by a hook bolt 44 secured by a cam lever 45. The first arm and the second arm surround a gasket generally of a ring shape whether a solid ring or a split version. In usage, a solid ring gasket is placed upon one pipe end. Then the second pipe end is brought close to the first pipe end and the gasket is moved to straddle both pipe ends. Next, the first arm is placed over the gasket with the hinge 42 towards the user then the second arm is folded below the gasket and the bight of the hook bolt brought to its pin. Lastly, the cam lever is pulled towards the second arm closing the coupler and securing the two pipes in an end to end connection that resists up to 2 bars of pressure.

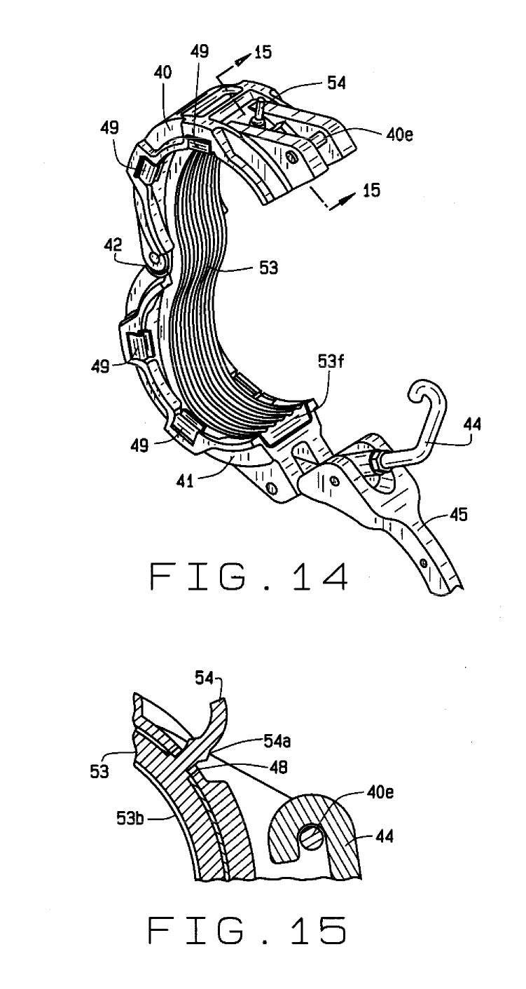

In usage, a split gasket 53 is placed into the arms 40, 41 as shown in FIG. 14. A user positions the two pipes with their ends close by. The user then opens the first arm 40 upwardly from the second arm 41 with the hinge away from the user. The user then grips the split gasket and positions the pull tabs 54 into the holes 48 in the arms as shown in the upper portion of the figure. In doing so, the free ends 53f of the gasket are generally flush with the second ends 40b, 41b of the arms proximate the cam lever 45 and the pin 40c. The midpoint of the split gasket generally locates proximate the hinge 42 where the rounded character of the hinge prevents pinching of the gasket between the arms during closure. After installing the gasket into the arms, the user positions the first arm above the pipe connection with the hinge towards the user. Then the user closers the second arm beneath the pipe connection and engages the hook bolt upon the pin. The user then lifts the cam lever towards the second arm securing the coupler upon the pipes for a tight connection. To open the coupler, these steps are reversed. Unlike the solid ring gasket, the split gasket allows the user to install the gasket into the arms of the coupler without placing the gasket upon the pipes ahead of time. The split gasket can be useful in cramped conditions or where singled sided access to pipes is the only way to connect them.

The operation of the pull tabs appears in more detail in FIG. 15. A user locates the split gasket into the groove of the coupler arms with the free ends 53f at the second ends of the arms as described. The user then inserts a pull tab 54 into a hole 48 in an arm until the wedge portion 54a abuts the arm. The larger diameter of the wedge section prevents inserting the pull tab completely through the hole. However, the materials of the gasket allow a user to pull upon a pull tab and lengthen it. In doing so, the diameter of the wedge section shrinks enough for the user to pass the wedge section through the hole 48 and secure one and then the other end of the split gasket to a coupler arm. Further, the holes 48 in each arm are elongated for a short distance tangent to the central aperture. The elongation allows the pull tab to slide somewhat which permits small adjustments to the gasket during closing or opening of the coupler upon pipe ends of any surface condition.

After usage of the coupler of this invention or for its installation upon two pipes in an alternate manner, the first arm 40 is opened from the second arm 41 as shown in FIG. 16, similar to FIG. 11, which is generally the opposite view from FIGS. 8, 9. During opening, a user removes the safety pin 47 and the seal from their respective holes, and then rotates a tee handle 55 counterclockwise to free it from the first arm. The tee handle has a generally cylindrical body 56 having two ends with one end in a pinned connection to the second arm as at 41c. The opposite end includes a threaded aperture that receives a threaded stem 57. Preferably, the threaded stem has right hand, coarse threads. Outwardly from the body along the stem, a tee 57a has its rounded end shown. The tee is generally cylindrical with an aperture through its center, midway along the length of the tee 57a through which the stem passes. Outwardly from the tee, a washer 58 fits upon the stem. The washer is preferably round, though other shapes known in the art are foreseen. Then upon the washer opposite the tee, a handle 59 joins to the stem. Here the handle has two portions, both as at 59, in a wing nut like configuration. The handle portions have sufficient length for an operator to develop leverage to rotate the handle turning the stem, while dirty, to open and to close the coupler. The handle also joins to a hex shaped head 60 at an end of the stem opposite the body. Generally the handle welds to the head. The head allows an operator to apply a wrench or other lever if additional leverage is required to open or to close the coupler. Here shown on end, the tee 57a engages the first arm when the coupler is closed. The tee approaches the outer end 62 of the first arm after an operator loosens the handle so that the stem moves the tee outwardly from the body. Turning the tee towards the first arm, the tee then passes over the extreme end of the first arm and takes a position within a curved rest 61.

The curved rest has a partial curvature of similar radius as the tee and the partial curvature extends upwardly from the extreme end of the first arm, preventing the tee from sliding off the first arm. With the tee positioned in the curved rest 61, an operator then turns the handle, typically clockwise. In doing so, the stem rotates axially into the body, pulling the second arm to the first arm for closing the coupler. With the handle turned to its final position, the tee comes to rest at the lowest point, as at 63, of the rest. For opening the coupler, an operator reverses the steps beginning with rotating the handle counterclockwise, lifting the tee above the curved rest, and then rotating the body and the tee handle away from the first arm and outwardly from the second arm. The first arm 40 and the second arm 41 still have clips 49 spaced upon their sidewalls 40e, 40f as shown. Opposite the second ends 40b, 41b of the arms and the tee handle, the arms hingedly connect as at 42 where a pin 42a extends through the first ends 40a, 41a. The first ends at the hinged connection are generally rounded as at 42b. The rounding of the first ends has a diameter of at least twice that of the pin 42a and extends the first ends slightly inward to the central aperture. The slight round extension of the first ends abuts any portion of the outer surface 53a of a gasket. The first ends gently urge the outer surface 53a away from the movement of the hinge and towards the central aperture. These rounded ends avoid pinching the gasket as occurs in prior art hinged connections with offset hinges and flat or non-rounded abutting faces.

It will be appreciated by those skilled in the art that various changes and modifications can be made in the coupler without departing from the scope of the appended claims. Furthermore, the various couplers are shown connecting sections of pipe. The coupler can also be to connect sections of pipe to hopper tees or other fittings. The coupler and its gasket accommodate both grooved and smooth ends of pipe.

From the aforementioned description, a pipe coupler with clips and gasket has been described. The coupler is uniquely capable of biting into the surface of any pipe end, preventing intrusion of a gasket between pipe ends, and avoiding pinching of the gasket at a hinge. Though some materials have been identified for the clips and the gasket, the coupler of the present invention contemplates using materials and various components that may be manufactured from many materials including but not limited to polymers, high density polyethylene HDPE, polypropylene PP, polyvinyl chloride PVC, nylon, ferrous and non-ferrous metals, their alloys and composites.

The phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A coupler for connecting two sections of pipe end to end, regardless of surface condition of the pipe, comprising:
a first arm having a first end and an opposite second end and a generally semi-circular shape;
a second arm having a first end and an opposite second end and a generally semi-circular shape, said second arm pivotally connecting to said first arm;
each of said first ends connecting together at a hinge;
a closure mechanism releasably connecting each of said second ends;
said first arm and said second arm each having a generally U shaped cross section with a first sidewall and a spaced apart second sidewall defining a groove for seating a gasket therein, said first sidewall and said second sidewall having at least a portion there along being thin;
at least two clips positioned upon the thin portions of said first sidewall and said second sidewall upon each of said first arm and said second arm, each of said clips having a return leg adapted to engage the surface of a pipe when placed in said coupler and adapted to transmit static electrical charge from one pipe through said coupler to another pipe; and,
said gasket capable of forming a round cylindrical shape and having an inside surface and an opposite outside surface, said outside surface engaging each of said grooves of said first arm and said second arm and said inside surface adapted to engage the surface of a pipe, said inside surface including an odd number of valleys and an even number of ridges wherein said gasket has a valley locating at the joint of two pipes in an end to end connection;
wherein said clips are adapted to engage the pipes as pressures within the pipes fluctuate thus preventing the connection of the pipes from disengaging longitudinally.

2. The regardless of pipe surface coupler of claim 1 further comprising:
each of said first ends having a rounded groove avoiding pinching of said gasket near said hinge.

3. The regardless of pipe surface coupler of claim 1 further comprising:
said first arm having a hole through said groove proximate said first end; and,
said second arm having a hole through said groove proximate said first end.

4. The regardless of pipe surface coupler of claim 3 further comprising:
said gasket having a thickness and a cut line extending from said outside surface to said inside surface through the thickness, said cut line defining two free ends of said gasket, said gasket having a circumference upon said outside surface greater than the circumference upon said inside surface, the circumference upon said outside surface defining an outside radius and the circumference upon said inside surface defining an inside radius, and each of said free ends having a cooperating undulating surface;
wherein said free ends mutually engage and mate completely thus retaining said gasket in cylindrical form and preventing leakage from said gasket;
said gasket having two cylindrical buttons extending perpendicular to said outside surface proximate each of said ends, each of said buttons entering each of said holes in said grooves of said first arm and said second arm, and said buttons securing said gasket into said grooves of said first arm and said second arm.

5. The regardless of pipe surface coupler of claim 4 wherein each of said buttons has a widened section portion preventing each of said buttons from falling out of said holes in said grooves.

6. The regardless of pipe surface coupler of claim 1 wherein said gasket self lubricates.

7. The regardless of pipe surface coupler of claim 1 further comprising:
said closure mechanism including a cam lever pivoting below said second arm, said cam lever pivotally connecting to said second end of said second arm and extending outwardly of said first end of said second arm;
a hook bolt pivotally connecting to said cam lever proximate said second end of said second arm, said hook bolt engaging said second end of said first arm to close said coupler; and,
a pin proximate said second end of said first arm, said pin receiving said hook bolt.

8. The regardless of pipe surface coupler of claim 7 wherein said cam lever in cooperation with said hinged connection allows a user to install and to remove said coupler from one side proximate said hinged connection.

9. The regardless of pipe surface coupler of claim 1 further comprising:
said closure mechanism including a tee handle pivotally connecting to said second end of said second arm;
said tee handle including an elongated cylindrical body with an axial threaded aperture, a threaded stem turning into said aperture, a cylindrical tee upon said stem generally perpendicular to said body, and a handle extending from said threaded stem outwardly of said body; and,
said first arm having a curved rest upon said second end, said curved receiving said tee when said second arm closes upon said first arm, and said curved rest having a similar radius as said tee.

10. The regardless of pipe surface coupler of claim 1 further comprising:
each of said clips having a generally U shape with a hook portion extending into a bight portion then extending into a return leg portion, said hook portion having a flat bottomed U shape and a slight inward bend securing said hook portion proximate one of said sidewalls, said return leg portion having a greater length than said bight portion, and said return leg extending below said hook portion adapting to engage the surface of a pipe; and,
each of said clips adapted to conduct electrical charge there through during grounding of two sections of pipe.

11. The regardless of pipe surface coupler of claim 1 wherein said gasket has six ridges alternating with five valleys and has one valley positioned at the joining of two sections of pipe.

12. The regardless of pipe surface coupler of claim 1 wherein said second arm has a tab with a hole through said tab and said cam lever has a tab opposite said second end of said second arm with a hole through said tab, upon aligning each of said holes on the tab of said second arm and the tab of said cam lever, said cam lever closes upon said second arm upon inserting a safety pin through the aligned holes.

13. A coupler for connecting two sections of pipe end to end, regardless of surface condition of the pipe, said coupler having a side accessible by a user, comprising:
a first arm hingedly connecting to a second arm, each of said arms having a first end and an opposite second end and a generally semi-circular shape;
a closure mechanism releasably connecting each of said second ends opposite the hinged connection of said arms;
said first arm and said second arm each having a generally U shaped cross section with a first sidewall and a spaced apart second sidewall defining a groove for seating a gasket therein, said first sidewall and said second sidewall having at least a portion being thin;
at least two clips positioned upon the thin portions of said first sidewall and said second sidewall upon each of said first arm and said second arm, each of said clips having a return leg adapted to engage the surface of a pipe when placed in said coupler and adapted to transmit static electrical charge from one pipe through said coupler to another pipe;
said gasket capable of forming a round cylindrical shape and having an inside surface and an opposite outside surface, said outside surface engaging is the grooves of said first arm and said second arm and said inside surface adapting to engage the surface of a pipe, said inside surface including sufficient valleys where a valley locates at a joint of two sections of pipe in an end to end connection; and,
wherein said clips further engage the two sections of pipe as pressures therein fluctuate thus preventing the pipes from disengaging longitudinally.

14. The regardless of pipe surface coupler of claim 13 further comprising:
said closure mechanism including one of a cam lever and a tee handle;
said cam lever pivoting below said second arm, said cam lever pivotally connecting to said second end of said second arm and extending outwardly of said first end of said second arm, a hook bolt pivotally connecting to said cam lever proximate said second end of said second arm, said hook bolt engaging said second end of said first arm to close said coupler, and a pin proximate said second end of said first arm, said pin receiving said hook bolt; and,
said tee handle pivotally connecting to said second end of said second arm, said tee handle including an elongated cylindrical body with an axial threaded aperture, a threaded stem turning into said aperture, a cylindrical tee upon said stem generally perpendicular to said body, and a handle extending from said threaded stem outwardly of said body, and said first arm having a curved rest upon said second end, said curved receiving said tee when said second arm closes upon said first arm, and said curved rest having a similar radius as said tee;
wherein said closure mechanism allows installation and removal of said coupler from one side proximate said hinged connection.
